(19) United States
(12) Patent Application Publication
(10) Pub. No.: US 2018/0244835 A1
(43) Pub. Date: Aug. 30, 2018

(54) CURABLE COMPOSITION, ADHESIVE, ARTICLE HAVING COATING LAYER, FIBER-REINFORCED COMPOSITE MATERIAL, POTTING AGENT AND CURABLE COMPOSITION KIT

(71) Applicant: Mitsubishi Chemical Corporation, Chiyoda-ku (JP)

(72) Inventors: Shunsuke CHATANI, Tokyo (JP); Hiromi Aso, Tokyo (JP)

(73) Assignee: Mitsubishi Chemical Corporation, Chiyoda-ku (JP)

(21) Appl. No.: 15/963,632

(22) Filed: Apr. 26, 2018

Related U.S. Application Data
(63) Continuation of application No. PCT/JP2016/081814, filed on Oct. 27, 2016.

(30) Foreign Application Priority Data
Nov. 4, 2015 (JP) 2015-216975
Nov. 4, 2015 (JP) 2015-216976
Aug. 2, 2016 (JP) 2016-152142

(51) Int. Cl. C08G 59/40; C08G 59/66; C08G 59/24; C08G 75/12; C09J 11/06; C09J 181/02; C09J 163/00; C08K 7/02; C08J 5/04

(52) U.S. Cl. CPC C08G 59/4028; C08G 59/66; C08G 59/4071; C08G 59/245; C08G 59/4064; C08G 75/12; C08J 2381/02; C09J 181/02; C09J 163/00; C08K 7/02; C08J 5/04; C08J 2363/00; C09J 11/06

(57) ABSTRACT

The present invention relates to a curable composition containing a thiol compound (A) having at least two thiol groups in a molecule thereof, an epoxy compound (B2) having at least two epoxy groups in a molecule thereof, a phosphine compound (C), and an acid (D); and, a curable composition containing the thiol compound (A), an epoxy compound (B1) having at least one epoxy group in a molecule thereof, an isocyanate compound (E2) having at least two isocyanate groups in a molecule thereof, a phosphine compound (C), and an acid (D).

### TECHNICAL FIELD

The present invention relates to a curable composition, an adhesive using the same, an article having a coating layer, a fiber-reinforced composite material and a curable composition kit.

The present application claims priority on the basis of Japanese Patent Application No. 2015-216975 filed on Nov. 4, 2015, Japanese Patent Application No. 2015-216976 filed on November 4, 2015, and Japanese Patent Application No. 2016-152142 filed on Aug. 2, 2016, the contents of which are incorporated herein.

### BACKGROUND ART

Curable compositions containing a thiol compound having at least two thiol groups in a molecule thereof and an epoxy compound having at least two epoxy groups in a molecule thereof are used as adhesives due to their superior adhesiveness.

In addition, these curable compositions are used as coating agents and matrices of fiber-reinforced composite materials due to the superior mechanical properties, heat resistance and chemical resistance of cured products thereof.

The following curable compositions containing a thiol compound and an epoxy compound have been proposed in the prior art:

(1) curable composition containing a thiol compound, epoxy compound and phosphine compound (Patent Document 1); and,

(2) curable composition containing an epoxy compound, thiol compound, isocyanate compound having an isocyanate group in a molecule thereof and a curing accelerator (Patent Document 2).

The curable composition of (1) can be cured in several tens of seconds at 100° C. to 120° C., has superior adhesiveness and has favorable storage stability.

The curable composition of (2) has even more superior adhesiveness as a result of further containing an isocyanate compound.

### PRIOR ART DOCUMENTS

Patent Document 1: Japanese Unexamined Patent Application, First Publication No. H11-12346

Patent Document 2: Japanese Unexamined Patent Application, First Publication No. H6-136100

### DISCLOSURE OF THE INVENTION

### Problems to be Solved by the Invention

Thiol compounds and epoxy compounds are frequently used in the form of two-component curable compositions. A cured product is obtained by mixing a composition containing a thiol compound with an epoxy compound or composition thereof in the presence of a catalyst. From the viewpoint of handling ease of the two-component curable composition, the pot life from the time the two components are mixed to the time gelling begins is preferably long to a certain degree. In addition, the two-component curable composition is preferably able to be cured at a low temperature in the case adhered objects to which an adhesive is to be applied or a substrate on which a coating agent is to be coated has low heat resistance.

However, a high temperature of 100° C. to 120° C. is required to cure the curable composition of (1).

Since the curable composition of (2) further contains an isocyanate compound, the isocyanate compound ends up reacting with the thiol compound prior to the epoxy compound reacting with the thiol compound. As a result, it becomes difficult to control pot life to an arbitrary time since fluidity of the curable composition ends up decreasing in a short period of time.

A first aspect of the present invention provides a curable composition that enables pot life to be controlled to an arbitrary time in a reaction between a thiol group of a thiol compound and an epoxy group of an epoxy compound and can be cured at a low temperature; an adhesive that demonstrates superior handling ease when adhering objects to be adhered and can be cured at a low temperature; an article having a coating layer that demonstrates superior mechanical properties, heat resistance and chemical resistance; a fiber-reinforced composite material that demonstrates superior mechanical properties, heat resistance and chemical resistance; a potting agent that is able to be filled into a hollow fiber membrane element without forming voids between the hollow fiber membrane bundles when immobilizing the ends of the hollow fiber membrane bundles, and is able to secure an adequate amount of time for removing air bubbles while also allowing a cured product to demonstrate superior solvent resistance and toughness; and, a two-component curable composition kit that undergoes little change over time during storage, enables pot life to be controlled to an arbitrary time in a reaction between a thiol group of a thiol compound and an epoxy group of an epoxy compound when mixed, can be cured at a low temperature, and demonstrates superior handling ease.

A second aspect of the present invention provides a curable composition that enables pot life to be controlled to an arbitrary time in a reaction between a thiol group of a thiol compound, an epoxy group of an epoxy compound and an isocyanate group of an isocyanate compound; an adhesive that demonstrates superior handling ease when adhering objects to be adhered; an article having a coating layer that demonstrates superior mechanical properties (such as toughness, impact resistance and abrasion resistance), heat resistance, chemical resistance and adhesiveness; a fiber-reinforced composite material that demonstrates superior mechanical properties (such as toughness, impact resistance and abrasion resistance), heat resistance, chemical resistance and adhesiveness; a potting agent that is able to be filled into a hollow fiber membrane element without forming voids between the hollow fiber membrane bundles when immobilizing the ends of the hollow fiber membrane bundles, and is able to secure an adequate amount of time for removing air bubbles while also allowing a cured product to demonstrate superior solvent resistance and toughness; and, a two-component curable composition kit that undergoes little changeover time during storage, enables pot life to be controlled to an arbitrary time in a reaction between a thiol group of a thiol compound, an epoxy group of an epoxy compound and an isocyanate group of an isocyanate compound when mixed, and demonstrates superior handling ease.

### Means for Solving the Problems

The first aspect of the present invention relates to a curable composition of the following <1> to <3> and <6> to <8>, an adhesive of the following <9>, an article of the following <10>, a fiber-reinforced composite material of the following <11>, a potting agent of the following <12>, and a curable composition kit of the following <13> and <14>.

The second aspect of the present invention relates to a curable composition of the following <4> to <8>, an adhesive of the following <9>, an article of the following <10>, a fiber-reinforced composition material of the following <11>, a potting agent of the following <12>, and a curable composition kit of the following <15>.

<1> A curable composition containing a thiol compound (A) having at least two thiol groups in a molecule thereof, an epoxy compound (B2) having at least two epoxy groups in a molecule thereof, a phosphine compound (C) and an acid (D).

<2> The curable composition of <1> above, further containing an isocyanate compound (E1) having one isocyanate group in a molecule thereof.

<3> The curable composition of <1> or <2> above, wherein the amount of the phosphine compound (C) is 0.1 parts by mass to 5 parts by mass based on the total amount (100 parts by mass) of the thiol compound (A), the epoxy compound (B2) and an isocyanate compound (E1) having one isocyanate group in a molecule thereof.

<4> A curable composition containing a thiol compound (A) having at least two thiol groups in a molecule thereof, an epoxy compound (B1) having at least one epoxy group in a molecule thereof, an isocyanate compound (E2) having at least two isocyanate groups in a molecule thereof, a phosphine compound (C) and an acid (D).

<5> The curable composition of <4> above, wherein the amount of the phosphine compound (C) is 0.1 parts by mass to 5 parts by mass based on the total amount (100 parts by mass) of the thiol compound (A), the epoxy compound (B1) and the isocyanate compound (E2).

<6> The curable composition of any of <1> to <5> above, wherein the acid dissociation constant (pKa) of the acid (D) relative to water is 3 or less.

<7> The curable composition of any of <1> to <6> above, wherein the phosphine compound (C) is a compound represented by the following formula (I):

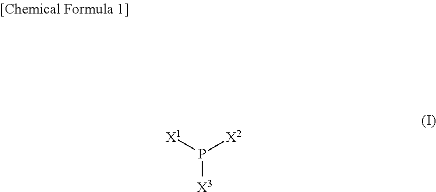

wherein, X¹, X² and X³ respectively represent an alkyl group having 1 to 8 carbon atoms, alkoxy group having 1 to 8 carbon atoms, alkenyl group having 1 to 8 carbon atoms, alkynyl group having 1 to 8 carbon atoms, cycloalkyl group having 3 to 6 carbon atoms, phenyl group, biphenyl group, naphthyl group, phenoxy group or heterocyclic group, X¹, X² and X³ may have a substituent, and the substituent is at least one group selected from the group consisting of a halogen atom, alkyl group having 1 to 8 carbon atoms, alkoxy group having 1 to 8 carbon atoms, alkenyl group having 1 to 8 carbon atoms, alkynyl group having 1 to 8 carbon atoms, cycloalkyl group having 3 to 6 carbon atoms, amino group, alkylamino group having 1 to 8 carbon atoms, nitro group, phenyl group, biphenyl group, naphthyl group, phenoxy group and heterocyclic group.

<8> The curable composition of any of <1> to <7> above, wherein the molar ratio ((D)/(C)) of the acid (D) to the phosphine compound (C) is 0.001 to 1.

<9> An adhesive containing the curable composition of any of <1> to <8> above.

<10> An article having a coating layer composed of the curable composition of any of <1> to <8> above.

<11> A fiber-reinforced composite material containing a matrix, composed of a cured product of the curable composition of any of <1> to <8> above, and reinforcing fibers.

<12> A potting agent for immobilizing the ends of hollow fiber membrane bundles in a hollow fiber membrane element, containing the curable composition of any of <1> to <8> above.

<13> A curable composition kit, having: a first container housing a composition (X) containing a thiol compound (A) having at least two thiol groups in a molecule thereof, a phosphine compound (C) and an acid (D), but not containing the following epoxy compound (B2); and, a second container housing a composition (Y) housing only the epoxy compound (B2) having at least two epoxy groups in a molecule thereof, or containing the epoxy compound (B2), but not containing the thiol compound (A), the phosphine compound (C) or the acid (D).

<14> The curable composition kit of <13> above, wherein the composition (X) also does not contain the following isocyanate compound (E1), and the composition (Y) contains the epoxy compound (B2) and the isocyanate compound (E1) having one isocyanate group in a molecule thereof.

<15> A curable composition kit having a first container housing a composition (X) containing a thiol compound (A) having at least two thiol groups in a molecular thereof, a phosphine compound (C) and an acid (D), but not containing the following epoxy compound (B1) or the following isocyanate compound (E2); and, a second container housing a composition (Y) containing the epoxy compound (B1) having at least one epoxy group in a molecular thereof and the isocyanate compound (E2) having at least two isocyanate groups in a molecule thereof, but not containing the thiol compound (A), the phosphine compound (C) or the acid (D).

### Effects of the Invention

The curable composition according to the first aspect of the present invention enables pot life to be controlled to an arbitrary time in a reaction between a thiol group of a thiol compound and an epoxy group of an epoxy compound, and can be cured at a low temperature.

The adhesive according to the first aspect of the present invention demonstrates superior handling ease when adhering objects to be adhered and can be cured at a low temperature.

The article according to the first aspect of the present invention has a coating layer that demonstrates superior mechanical properties, heat resistance and chemical resistance.

The fiber-reinforced composite material according to the first aspect of the present invention demonstrates superior mechanical properties, heat resistance and chemical resistance.

The potting agent according to the first aspect of the present invention can be filled into a hollow fiber membrane element without forming voids between hollow fiber membrane bundles when immobilizing the ends of the hollow fiber membrane bundles, and is able to secure an adequate amount of time for removing air bubbles while also allowing a cured product to demonstrate superior solvent resistance.

The curable composition kit of the first aspect of the present invention undergoes little change over time during storage, enables pot life to be controlled to an arbitrary time in a reaction between a thiol group of a thiol compound and an epoxy group of an epoxy compound when mixed, can be cured at a low temperature, and demonstrates superior handling ease.

The curable composition according to the second aspect of the present invention enables pot life to be controlled to an arbitrary time in a reaction between a thiol group of a thiol compound, an epoxy group of an epoxy compound and an isocyanate group of an isocyanate compound.

The adhesive according to the second aspect of the present invention demonstrates superior handling ease when adhering objects to be adhered.

The article according to the second aspect of the present invention demonstrates superior mechanical properties (such as toughness, impact resistance and abrasion resistance), heat resistance, chemical resistance and adhesiveness of the coating layer thereof.

The fiber-reinforced composite material according to the second aspect of the present invention demonstrates superior mechanical properties (such as toughness, impact resistance and abrasion resistance), heat resistance, chemical resistance and adhesiveness.

The potting agent according to the second aspect of the present invention can be filled into a hollow fiber membrane element without forming voids between the hollow fiber membrane bundles when immobilizing the ends of the hollow fiber membrane bundles and is able to secure an adequate amount of time for removing air bubbles while also allowing a cured product to demonstrate superior solvent resistance and toughness.

The curable composition kit according to the second aspect of the present invention provides a two-component curable composition undergoes little change over time during storage, enables pot life to be controlled to an arbitrary time in a reaction between a thiol group of a thiol compound, an epoxy group of an epoxy compound and an isocyanate group of an isocyanate compound when mixed, and demonstrates superior handling ease.

### BEST MODE FOR CARRYING OUT THE INVENTION

Definitions of the following terms are applied in the present description and claims.

“Acid dissociation constant (pKa)” is that value in the case the value is known in the literature, or is a calculated value determined using Advanced Chemistry Development (ACD/Labs) software in the case the value is not known in the literature.

“(Meth)acrylic acid” is the collective term for acrylic acid and methacrylic acid.

“(Meth)acrylate” is the collective term for acrylate and methacrylate.

<Curable Composition According to First Aspect of Present Invention>

The curable composition according to the first aspect of the present invention contains a thiol compound (A) having at least two thiol groups in a molecule thereof, an epoxy compound (B2) having at least two epoxy groups in a molecule thereof, a phosphine compound (C), and an acid (D).

The curable composition according to the first aspect of the present invention may further contain an isocyanate compound (E1) having one isocyanate group in a molecule thereof.

(Thiol Compound (A))

There are no particular limitations on the thiol compound (A) provided it is a compound that has at least two thiol groups (mercapto groups, —SH) in a molecule thereof.

Examples of thiol compound (A) include aliphatic polythiol compounds, aromatic polythiol compounds, aromatic polythiol compounds having a sulfur atom other than a thiol group (mercapto group), and aliphatic polythiol compounds having a sulfur atom other than a thiol group (mercapto group).

Examples of aliphatic polythiol compounds include methanedithiol, 1,2-ethanedithiol, 1,1-propanedithiol, 1,2-propanedithiol, 1,3-propanedithiol, 2,2-propanedithiol, 1,6-hexanedithiol, 1,2,3-propanetrithiol, 1,1-cyclohexanedithiol, 1,2-cyclohexanedithiol, 2,2-dimethylpropane-1,3-dithiol, 3,4-dimethoxybutane-1,2-dithiol, 2-methylcyclohexane-2,3-dithiol, 1,1-bis(mercaptomethyl)cyclohexane, bis(2-mercaptoethylester)thiomalate, 2,3-dimercapto-1-propanol(2-mercaptoacetate), 2,3-dimercapto-1-propanol(3-mercaptopropionate), 2,3-dimercapto-1-propanol(3-mercaptobutyrate), diethylene glycol bis(2-mercaptoacetate), diethylene glycol bis(3-mercaptopropionate), diethylene glycol bis(3-mercaptobutyrate), 1,2-dimercaptopropyl methyl ether, 2,3-dimercaptopropyl methyl ether, 2,2-bis(mercaptomethyl)-1,3-propanedithiol, bis(2-mercaptoethyl)ether, ethylene glycol bis(2-mercaptoacetate), ethylene glycol bis(3-mercaptopropionate), ethylene glycol bis(mercaptobutyrate), trimethylolpropane bis(2-mercaptoacetate), trimethylolpropane bis(3-mercaptopropionate), trimethylolpropane bis(3-mercaptobutyrate), pentaerythritol tetrakis(2-mercaptoacetate), pentaerythritol tetrakis(3-mercaptopropionate), pentaerythritol tetrakis(3-mercaptobutyrate) and tetrakis(mercaptomethyl)methane.

Examples of aromatic polythiol compounds include 1,2-dimercaptobenzene, 1,3-dimercaptobenzene, 1,4-dimercaptobenzene, 1,2-bis(mercaptomethyl)benzene, 1,3-bis(mercaptomethyl)benzene, 1,4-bis(mercaptomethyl)benzene, 1,2-bis(mercaptoethyl)benzene, 1,3-bis(mercaptoethyl)benzene, 1,4-bis(mercaptoethyl)benzene, 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene, 1,3,5-tris(mercaptomethyl)benzene, 1,2,3-tris(mercaptoethyl)benzene, 1,2,4-tris(mercaptoethyl)benzene, 1,3,5-tris(mercaptoethyl)benzene, 2,5-toluenedithiol, 3,4-toluenedithiol, 1,3-di(p-methoxyphenyl)propane-2,2-dithiol, 1,3-diphenylpropane-2,2-dithiol, phenylmethane-1,1-dithiol and 2,4-di(p-mercaptophenyl)pentane.

Examples of aromatic polythiol compounds having a sulfur atom other than a thiol group (mercapto group) include 1,2-bis(mercaptoethylthio)benzene, 1,3-bis(mercaptoethylthio)benzene, 1,4-bis(mercaptoethylthio)benzene, 1,2,3-tris(mercaptomethylthio)benzene, 1,2,4-tris(mercaptomethylthio)benzene, 1,3,5-tris(mercaptomethylthio)benzene, 1,2,3-tris(mercaptoethylthio)benzene, 1,2,4-tris(mercaptoethylthio)benzene, 1,3,5-tris(mercaptoethylthio)benzene and these alkylation products thereof.

Examples of aliphatic polythiols containing a sulfur atom other than a thiol group (mercapto group) include bis(mercaptomethyl) sulfide, bis(mercaptomethyl) disulfide, bis(mercaptoethyl) sulfide, bis(mercaptoethyl) disulfide, bis(mercaptopropyl) sulfide, bis(mercaptomethylthio)methane, bis(2-mercaptoethylthio)methane, bis(3-mercaptopropylthio)methane, 1,2-bis(mercaptomethylthio)ethane, 1,2-bis(2-mercaptoethylthio)ethane, 1,2-bis(3-mercaptopropyl)ethane, 1,3-bis((mercaptomethylthio)propane, 1,3-bis(2-mercaptoethylthio)propane, 1,3-bis(3-mercaptopropylthio)propane, 1,2,3-tris(mercaptomethylthio)propane, 1,2,3-tris(2-mercaptoethylthio)propane, 1,2,3-tris(3-mercaptopropylthio)propane, 1,2-bis[(2-mercaptoethyl)thio]-3-mercaptopropane, 4-mercaptomethyl-3,6-dithia-1,8-octanedithiol, 4,8-dimercaptomethyl-1,11-mercapto-3,6,9-trithioundecane, 4,7-dimercaptomethyl-1,11-mercapto-3,6,9-trithioundecane, 5,7-dimercaptomethyl-1,11-mercapto-3,6,9-trithiaundecane, tetrakis(mercaptomethylthiomethyl)methane, tetrakis(2-mercaptoethylthiomethyl)methane, tetrakis(3-mercaptopropylthiomethyl)methane, bis(2,3-dimercaptopropyl) sulfide, bis(1,3-dimercaptopropyl) sulfide, 2,5-dimercapto-1,4-dithiane, 2,5-dimercaptomethyl-1,4-dithiane, 2,5-dimercaptomethyl-2,5-dimethyl-1,4-dithiane, bis(mercaptomethyl) disulfide, bis(mercaptoethyl) disulfide, bis(mercaptopropyl) disulfide, and thioglycolates, mercaptopropionates and mercaptobutanoates thereof; hydroxymethylsulfide bis(2-mercaptoacetate), hydroxymethylsulfide bis(3-mercaptopropionate), hydroxymethylsulfide bis(3-mercaptobutyrate), hydroxyethylsulfide bis(2-mercaptoacetate), hydroxyethylsulfide bis(3-mercaptopropionate), hydroxyethylsulfide bis(3-mercaptobutyrate), hydroxypropylsulfide bis(2-mercaptoacetate), hydroxypropylsulfide bis(3-mercaptopropionate), hydroxypropylsulfide bis(3-mercaptobutyrate), hydroxymethyldisulfide bis(2-mercaptoacetate), hydroxymethyldisulfide bis(3-mercaptopropionate), hydroxymethyldisulfide bis(3-mercaptobutyrate), hydroxyethyldisulfide bis(2-mercaptoacetate), hydroxyethyldisulfide bis(3-mercaptopropionate), hydroxyethyldisulfide bis(3-mercaptobutyrate), hydroxypropyldisulfide bis(2-mercaptoacetate), hydroxypropyldisulfide bis(3-mercaptopropionate), hydroxypropyldisulfide bis(3-mercaptobutyrate), 2-mercaptoethyl ether bis(2-mercaptoacetate), 2-mercaptoethyl ether bis(3-mercaptopropionate), 2-mercaptoethyl ether bis(3-mercaptobutyrate), 1,4-dithiane-2,5-diol bis(2-mercaptoacetate), 1,4-dithiane-2,5-diol bis(3-mercaptopropionate), 1,4-dithiane-2,5-diol bis(3-mercaptobutyrate), bis(2-mercaptoethylester) thiodiglycolate, bis(2-mercaptoethylester) thiodipropionate, bis(2-mercaptoethylester) thiodibutanoate, bis(2-mercaptoethylester) 4,4-thiodibutyrate, bis(2-mercaptoethylester) dithiodiglycolate, bis(2-mercaptoethylester) dithiodipropionate, bis(2-mercaptoethylester) dithiodibutanoate, bis(2-mercaptoethylester) 4,4-dithiodibutyrate, bis(2,3-dimercaptopropylester) thiodiglycolate, bis(2,3-dimercaptopropylester) thiodiglycolate, bis(2,3-dimercaptopropylester) thiodibutanoate, bis(2,3-dimercaptopropylester) dithioglycolate, bis(2,3-dimercaptopropylester) dithiodipropionate, and bis(2,3-dimercaptopropylester) dithiodibutanoate.

One type of thiol compound (A) may be used alone or two or more types may be used in combination.

(Epoxy Compound (B2))

There are no particular limitations on the epoxy compound (B2) provided it is a compound having at least two epoxy groups in a molecule thereof.

Examples of epoxy compound (B2) include bisphenol-type epoxy resins, novolac-type epoxy resins and compounds having a glycidyl group.

Examples of bisphenol-type epoxy resins include bisphenol A-type epoxy resins, bisphenol F-type epoxy resins and bisphenol A/bisphenol F copolymer-type epoxy resins.

Examples of novolac-type epoxy resins include cresol novolac-type epoxy resins and phenol novolac-type epoxy resins.

Examples of compounds having a glycidyl group include triglycidyl aminophenols, biphenyl diglycidyl ethers, triglycidyl isocyanurates, polyglycidyl (meth)acrylates and copolymers of glycidyl (meth)acrylate and vinyl monomers capable of copolymerizing therewith.

One type of epoxy compound (B2) may be used alone or two or more types may be used in combination.

(Isocyanate Compound (E1))

Adhesiveness becomes even more superior in the case the curable composition according to the first aspect of the present invention contains the isocyanate compound (E1).

There are no particular limitations on isocyanate compound (E1) provided it is a compound that has one isocyanate group in a molecule thereof.

Examples of isocyanate compound (E1) include n-butyl isocyanate, isopropyl isocyanate, 2-chloroethyl isocyanate, phenyl isocyanate, p-chlorophenyl isocyanate, benzyl isocyanate and 2-ethylphenyl isocyanate.

(Phosphine Compound (C))

Phosphine compound (C) functions as a catalyst of a reaction consisting of nucleophilic addition to the epoxy compound (B2) followed by the resulting strongly basic zwitterion intermediate reacting with a thiol group and epoxy group.

Examples of phosphine compound (C) include phosphines and diphosphines.

Examples of phosphines include trimethylphosphine, triethylphosphine, tripropylphosphine, triisopropylphosphine, tri-n-butylphosphine, tri-t-butylphosphine, tri-n-octylphosphine, tricyclohexylphosphine, tribenzylphosphine, triphenylphosphine, diphenylmethylphosphine, dimethyphenylphosphine, diphenylcyclohexylphosphine, dicyclohexylphenylphosphine, diethylphenylphosphine, tri-o-tolylphosphine, tri-m-tolylphosphine, tri-p-tolylphosphine, tri-2,4-xylylphosphine, tri-2,5-xylylphosphine, tri-3,5-xylylphosphine, tris(p-methoxyphenyl)phosphine, tris(p-t-butoxyphenyl)phosphine, di-t-butylphenylphosphine, [4-(N,N-dimethylamino)phenyl]di-t-butylphosphine, di-t-butyl(2-butenyl)phosphine, di-t-butyl(3-methyl-2-butenyl)phosphine and trimesitylphosphine.

Examples of diphosphines include 1,2-bis(dimethylphosphino)ethane, bis(diphenylphosphino)methane, 1,2-bis(diphenylphosphino)ethane, 1,2-bis(diphenylphosphino)propane, 1,3-bis(diphenylphosphino)propane, 1,4-bis(diphenylphosphino)butane, 2,3-bis(diphenylphosphino)butane and 1,5-bis(diphenylphosphino)pentane.

One type of phosphine compound (C) may be used alone or two or more types may be used in combination.

Phosphine compound (C) is preferably compound (I) represented by the following formula (I) from the viewpoint of having nucleophilicity suitable for nucleophilic addition to the epoxy compound (B2).

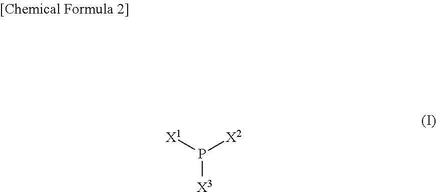

In the aforementioned formula (I), X¹, X² and X³ respectively represent an alkyl group having 1 to 8 carbon atoms, alkoxy group having 1 to 8 carbon atoms, alkenyl group having 1 to 8 carbon atoms, alkynyl group having 1 to 8 carbon atoms, cycloalkyl group having 3 to 6 carbon atoms, phenyl group, biphenyl group, naphthyl group, phenoxy group or heterocyclic group.

The alkyl group, alkoxy group, alkenyl group and alkynyl group may be respectively be linear or branched.

X¹, X² and X³ may have a substituent.

Examples of substituents include a halogen atom, alkyl group having 1 to 8 carbon atoms, alkoxy group having 1 to 8 carbon atoms, alkenyl group having 1 to 8 carbon atoms, alkynyl group having 1 to 8 carbon atoms, cycloalkyl group having 3 to 6 carbon atoms, amino group, alkylamino group having 1 to 8 carbon atoms, nitro group, phenyl group, biphenyl group, naphthyl group, phenoxy group and heterocyclic group.

(Acid (D))

The acid (D) inhibits the reaction between a thiol group and epoxy group by inhibiting formation of the strongly basic zwitterion intermediate by forming a complex with the phosphine compound (C).

The pKa of the acid (D) is preferably 3 or less. If the pKa of the acid (D) is 3 or less, acidity is sufficiently high and the effect of inhibiting the reaction between a thiol group and epoxy group is easily obtained.

Since the pKa relative to water of a conjugate acid (X¹X²X³P^{|}—H) of phosphine compound (C), such as a conjugate acid of triphenylphosphine, is 2, the pKa of the acid (D) (AH) is sufficiently lower than the pKa of the conjugate acid (X¹X²X³P⁺—H) of phosphine compound (C), or in other words, if pKa is 1 or less, the acid (D) (AH) easily forms a complex (X¹X²X³P⁺—H·A⁻) with the phosphine compound (C) (X¹X²X³P).

Accordingly, the pKa of the acid (D) relative to water is preferably 1 or less, more preferably 0 or less and even more preferably −1 or less. If the pKa of the acid (D) is 1 or less, acidity is sufficiently high and the effect of inhibiting the reaction between a thiol group and epoxy group can be sufficiently obtained.

Examples of acid (D) include perfluorocarboxylic acids, perfluorosulfonic acids, aromatic sulfonic acids, aliphatic sulfonic acids, reactive sulfonic acids and inorganic acids.

Examples of perfluorocarboxylic acids include trifluoroacetic acid (pKa: 0.1), pentafluoropropionic acid (pKa: 0.4) and perfluoro-n-octanoic acid (pKa: 0.5).

Examples of perfluorosulfonic acids include trifluoromethanesulfonic acid (pKa: −3.9).

Examples of aromatic sulfonic acids include benzenesulfonic acid (pKa: −2.8), p-toluenesulfonic acid (pKa: −2.8), naphthalenesulfonic acid (pKa: 0.3), anthracenesulfonic acid (pKa: 0.2), phenanthracenesulfonic acid (pKa: 0.2), fluorenesulfonic acid (pKa: −0.6), indanesulfonic acid (pKa: −0.4), indenesulfonic acid (pKa: −0.5), tetralinsulfonic acid (pKa: −0.4), acenaphthenesulfonic acid (pKa: 0.7), cumenesulfonic acid (pKa: −0.5), p-xylene-2-sulfonic acid (pKa: −0.5), dodecylbenzenesulfonic acid (pKa: −0.5), nonylnaphthalenesulfonic acid (pKa: 0.4) and 2-aminotoluene-5-sulfonic acid (pKa: −1.1).

Examples of aliphatic sulfonic acids include methanesulfonic acid (pKa: −1.9).

Examples of reactive sulfonic acids include vinylsulfonic acid (pKa: −2.7), styrenesulfonic acid (pKa: −0.6), isoprenesulfonic acid (pKa: −2.7), allyloxybenzenesulfonic acid (pKa: −0.4) and methalyloxybenzenesulfonic acid (pKa: −0.4).

Examples of inorganic acids include sulfuric acid (pKa: −3.2, monovalent acid), hydrochloric acid (pKa: −3.7), nitric acid (pKa: −1.8) and hydrobromic acid (pKa: −4.1).

One type of acid (D) may be used alone or two or more types may be used in combination.

The acid (D) is preferably an aromatic sulfonic acid. Since aromatic sulfonic acids have a comparatively high molecular mass, the acid value per unit mass thereof is low and the increase in pot life relative to the amount added is more gradual. As a result, pot life can be controlled to an arbitrary time in the reaction between a thiol group and epoxy group.

(Other Components)

The curable composition according to the first aspect of the present invention may also contain a monofunctional thiol or monofunctional epoxy for the purpose of adjusting the crosslink density of the cured product.

The curable composition according to the first aspect of the present invention may also contain additives such as a pigment, ultraviolet absorber, adhesion promoter, stabilizer, antioxidant, antifoaming agent, filler, anti-settling agent, plasticizer, viscosity modifier or solvent as necessary.

(Ratios of Each Component)

The molar ratio (SH/epoxy group) of all thiol groups to all epoxy groups present in the curable composition according to the first aspect of the present invention is preferably 0.2/1 to 2/1 and more preferably 0.5/1 to 2/1 from the viewpoints of mechanical properties, heat resistance and chemical resistance of the cured product.

The amount of the phosphine compound (C) in the curable composition according to the first aspect of the present invention is preferably 0.1 parts by mass to 5 parts by mass and more preferably 0.1 parts by mass to 3 parts by mass based on the total amount (100 parts by mass) of the thiol compound (A), the epoxy compound (B2) and the isocyanate compound (E1). A rapid reaction rate can be obtained without having a detrimental effect on material properties if the amount of the phosphine compound (C) is within the aforementioned ranges.

The molar ratio ((D)/(C)) of the acid (D) to the phosphine compound (C) in the curable composition according to the first aspect of the present invention is preferably 0.001 to 1 and more preferably 0.01 to 0.6. If the ratio ((D)/(C)) is within the aforementioned ranges, a pot life of several minutes to several hours can be obtained without completely inhibiting initiation of the reaction.

(Mechanism of Action)

In the first aspect of the present invention, the phosphine compound (C) and the acid (D) are used as catalysts of the reaction between a thiol group of the thiol compound (A) and an epoxy group of the epoxy compound (B2). The phosphine compound (C) carries out nucleophilic addition to the epoxy compound (B2) and the strongly basic zwitterion intermediate formed functions as a catalyst of the reaction between the thiol group and epoxy group. Here, since the acid (D) functions as an inhibitor of the reaction between the thiol group and epoxy group if present, an arbitrary pot life can be obtained due to the generation of a delay in the start of the reaction corresponding to the amount of the acid (D) added. This is the first effect of adding the acid (D).

The following provides a description of the second effect of adding the acid (D). Since the acid (D) forms a complex with the phosphine compound (C), the concentration of phosphine compound (C) that demonstrates nucleophilic addition decreases, and the rate at which the phosphine compound (C) carries out nucleophilic addition on the epoxy compound (B2) decreases. Namely, rapid formation of the strongly basic zwitterion intermediate (catalyst) is inhibited and as a result thereof, the start of the reaction between the thiol group and epoxy group is delayed, thereby allowing the obtaining of pot life.

Thus, according to the present invention, by selecting the types and amounts of the phosphine compound (C) and the acid (D), pot life can be controlled to an arbitrary time in the reaction between a thiol group of the thiol compound (A) and an epoxy group of the epoxy compound (B2).

In addition, in the curable composition of the present invention, the phosphine compound (C) carries out nucleophilic addition on the epoxy compound (B2), and the strongly basic zwitterion intermediate formed functions as a catalyst of the reaction between a thiol group and epoxy group. Since this nucleophilic addition reaction proceeds even at low temperatures, the curable composition according to the first aspect of the present invention can be cured at low temperatures.

<Curable Composition Kit According to First Aspect of Present Invention>

Since the thiol compound (A) and the epoxy compound (B2) react even in the absence of a catalyst, the curable composition according to the first aspect of the present invention is normally used in the form of a two-component curable composition composed of a composition (X), containing the thiol compound (A) but not containing the epoxy compound (B2), and a composition (Y), composed of the epoxy compound (B2) or containing the epoxy compound (B2) but not containing the thiol compound (A).

Since the phosphine compound (C) and the acid (D) react with the epoxy compound (B2), the phosphine compound (C) and the acid (D) are contained in the composition (X) that does not contain the epoxy compound (B2).

In addition, as a result of the phosphine compound (C) and the acid (D) being contained in the same composition (X), the phosphine compound (C) and the acid (D) form a complex and an epoxy ring-opening reaction catalyzed by the acid (D) does not proceed.

Thus, the two-component curable composition is preferably composed of the component (X), which contains the thiol compound (A), the phosphine compound (C) and the acid (D), but does not contain the epoxy compound (B2), and the composition (Y), which is composed of the epoxy compound (B2) or contains the epoxy compound (B2) but does contain the thiol compound (A), the phosphine compound (C) or the acid (D).

In the case the curable composition according to the first aspect of the present invention contains the isocyanate compound (E1), the composition (X) does not further contain the isocyanate compound (E1), but rather the composition (Y) contains the epoxy compound (B2) and the isocyanate compound (E1).

The two-component curable composition is preferably supplied in the form of a cured composition kit having a first container housing the composition (X) and only a second container housing the epoxy compound (B2) or the composition (Y).

According to the curable composition kit according to the first aspect of the present invention, a two-component curable composition can be provided that undergoes little changes in time during storage, enables pot life to be controlled to an arbitrary time in a reaction between a thiol group of the thiol compound (A) and an epoxy group of the epoxy compound (B2) when mixed, can be cured at a low temperature, and demonstrates superior handling ease.

<Curable Composition According to Second Aspect of Present Invention>

The curable composition according to the second aspect of the present invention contains a thiol compound (A) having at least two thiol groups in a molecule thereof, an epoxy compound (B1) having at least one epoxy group in a molecule thereof, an isocyanate compound (E2) having at least two isocyanate groups in a molecule thereof, a phosphine compound (C), and an acid (D).

(Thiol Compound (A))

There are no particular limitations on the thiol compound (A) provided it is a compound that has at least two thiol groups (mercapto groups, —SH) in a molecule thereof.

Examples and preferable aspects of thiol compound (A) are the same as those of the thiol compound (A) in the curable composition of the first aspect of the present invention.

(Epoxy Compound (B1))

There are no particular limitations on the epoxy compound (B1) provided it is a compound having at least two epoxy groups in a molecule thereof.

Examples and preferable aspects of epoxy compound (B1) are the same as those of the epoxy compound (B2) in the curable composition of the first aspect of the present invention.

(Isocyanate Compound (E2))

There are no particular limitations on the isocyanate compound (E2) provided it is a compound having at least two isocyanate compounds in a molecule thereof.

Examples of isocyanate compound (E2) include diisocyanates, modified isocyanates and triisocyanates.

Examples of diisocyanates include 1,2-diisocyanatobenzene, 1,3-diisocyanatobenzene, 1,4-diisocyanatobenzene, 2,4-diisocyanatotoluene, ethylphenylene diisocyanate, isopropylphenylene diisocyanate, dimethylphenylene diisocyanate, diethylphenylene diisocyanate, diisopropylphenylene diisocyanate, biphenyl diisocyanate, toluidine diisocyanate, 4,4′-methylenebis(phenylisocyanate), 4,4′-methylenebis(2-methylphenylisocyanate), bibenzyl-4,4′-diisocyanate, bis(isocyanatophenyl)ethylene, isophorone diisocyanate, 1,4-tetramethylene diisocyanate, 1,6-hexamethylene diisocyanate, cyclohexane diisocyanate, methylcyclohexane diisocyanate, 4,4′-methylenebis(cyclohexylisocyanate), 4,4′-methylenebis(2-methylcyclohexylisocyanate), 3,8-bis(isocyanatomethyl)tricyclodecane, 3,9-bis(isocyanatomethyl)tricyclodecane, 4,8-bis(isocyanatomethyl)tricyclodecane and 4,9-bis(isocyanatomethyl)tricyclodecane.

Examples of modified isocyanates include biuret and isocyanurate diisocyanates.

Examples of triisocyanates include triisocyanatononane, triphenylmethylene triisocyanate, trimethylbenzene triisocyanate, benzene triisocyanate and toluene triisocyanate.

Other examples of isocyanate compound (E2) include isocyanate compounds obtained by extending chain length with one or more polyamines and/or polyols using suitable materials and techniques known among persons with ordinary skill in the art.

One type of isocyanate compound (E2) may be used alone or two or more types may be used in combination.

(Phosphine Compound (C))

Phosphine compound (C) functions as a catalyst of a reaction consisting of nucleophilic addition to the epoxy compound (B1) followed by the resulting strongly basic zwitterion intermediate reacting with a thiol group and isocyanate group.

A typical known example of a catalyst used in a reaction between a thiol group and isocyanate group or between a thiol group and epoxy group is a tertiary amine. However, since the reaction rate between a thiol group and isocyanate group catalyzed by a tertiary amine is excessively fast, it is difficult to use an amount adequate for catalyzing the reaction between a thiol group and epoxy group. Here, the use of the phosphine compound (C) makes it possible to slow the start of the reaction between a thiol group and isocyanate group, thereby making it possible to combine the reaction between a thiol group and isocyanate group and the reaction between a thiol group and epoxy group.

Examples and preferable aspects of the phosphine compound (C) are the same as those of the phosphine compound (C) in the curable composition of the first aspect of the present invention.

The phosphine compound (C) is preferably compound (I) represented by the aforementioned formula (I) from the viewpoint of having nucleophilicity suitable for nucleophilic addition to the epoxy compound (B1).

(Acid (D))

The acid (D) inhibits the reaction between a thiol group and isocyanate group and the reaction between a thiol group and epoxy group by forming a complex with the phosphine compound (C).

The pKa of the acid (D) is preferably 3 or less. If the pKa of the acid (D) is 3 or less, acidity is sufficiently high and the effect of inhibiting the reaction between a thiol group and isocyanate group and the reaction between a thiol group and epoxy group is easily obtained.

Since the pKa relative to water of a conjugate acid (X¹X²X³P⁺—H) of phosphine compound (C), such as a conjugate acid of triphenylphosphine, is 2, the pKa of the acid (D) (AH) is sufficiently lower than the pKa of the conjugate acid (X¹X²X³P⁺—H) of phosphine compound (C), or in other words, if pKa is 1 or less, the acid (D) (AH) easily forms a complex (X¹X²X³P⁺—H·A⁻) with the phosphine compound (C) (X¹X²X³P).

Accordingly, the pKa of the acid (D) relative to water is preferably 1 or less, more preferably 0 or less and even more preferably −1 or less. If the pKa of the acid (D) is 1 or less, acidity is sufficiently high and the effect of inhibiting the reaction between a thiol group and isocyanate group and the reaction between a thiol group and epoxy group can be sufficiently obtained.

Examples and preferred aspects of acid (D) are the same as those of the acid (D) in the curable composition of the first aspect of the present invention.

Acid (D) is preferably an aromatic sulfonic acid. Since aromatic sulfonic acids have a comparatively high molecular mass, the acid value per unit mass thereof is low and the increase in pot life relative to the amount added is more gradual. As a result, pot life is easily controlled to an arbitrary time in the reaction between a thiol group and isocyanate group and the reaction between a thiol group and an epoxy group.

(Other Components)

The curable composition according to the second aspect of the present invention may also contain additives such as a pigment, ultraviolet absorber, adhesion promoter, stabilizer, antioxidant, antifoaming agent, filler, anti-settling agent, plasticizer, viscosity modifier or solvent as necessary.

(Ratios of Each Component)

The molar ratio (SH/epoxy group) of all thiol groups to all epoxy groups present in the curable composition according to the second aspect of the present invention is preferably 0.2/1 to 10/1 and more preferably 0.2/1 to 5/1 from the viewpoints of mechanical properties, heat resistance and chemical resistance of the cured product.

The molar ratio (SH/NCO) of all thiol groups to all isocyanate groups present in the curable composition according to the second aspect of the present invention is preferably 0.2/1 to 10/1 and more preferably 0.2/1 to 5/1 from the viewpoints of toughness, impact resistance, abrasion resistance and adhesiveness of the cured product.

The amount of the phosphine compound (C) in the curable composition according to the second aspect of the present invention is preferably 0.1 parts by mass to 5 parts by mass and more preferably 0.1 parts by mass to 3 parts by mass based on the total amount (100 parts by mass) of the thiol compound (A), the epoxy compound (B1) and the isocyanate compound (E2). A rapid reaction rate can be obtained without having a detrimental effect on material properties if the amount of the phosphine compound (C) is within the aforementioned ranges.

The molar ratio ((D)/(C)) of the acid (D) to the phosphine compound (C) in the curable composition according to the second aspect of the present invention is preferably 0.001 to 1 and more preferably 0.001 to 0.5. If the ratio ((D)/(C)) is within the aforementioned ranges, a pot life of several minutes to several hours can be obtained without completely inhibiting initiation of the reaction.

(Mechanism of Action)

In the second aspect of the present invention, the phosphine compound (C) and the acid (D) are used as catalysts of the reaction between a thiol group of the thiol compound (A), an epoxy group of the epoxy compound (B1), and an isocyanate group of the isocyanate compound (E2). The phosphine compound (C) carries out nucleophilic addition to the epoxy compound (B1) and the strongly basic zwitterion intermediate formed functions as a catalyst of the reaction between a thiol group and isocyanate group and the reaction between a thiol group and an epoxy group. Here, since the acid (D) functions as an inhibitor of the reaction between the thiol group and isocyanate group and an inhibitor of the reaction between a thiol group and epoxy group if present, an arbitrary pot life can be obtained due to the generation of a delay in the start of the reaction corresponding to the amount of the acid (D) added. This is the first effect of adding the acid (D).

The following provides a description of the second effect of adding the acid (D). Since the acid (D) forms a complex with the phosphine compound (C), the concentration of phosphine compound (C) that demonstrates nucleophilic addition decreases, and the rate at which the phosphine compound (C) carries out nucleophilic addition on the epoxy compound (B1) decreases. Namely, rapid formation of the strongly basic zwitterion intermediate (catalyst) is inhibited and as a result thereof, the start of the reactions between a thiol group and isocyanate group and between a thiol group and epoxy group is delayed, thereby allowing the obtaining of pot life.

Since the phosphine compound (C) is used as catalyst instead of a tertiary amine, the start of the reaction between a thiol group and isocyanate group can be slowed, thereby making it possible to combine the reaction between a thiol group and isocyanate group and the reaction between a thiol group and epoxy group.

Thus, according to the second aspect of the present invention, by using the phosphine compound (C) and the acid (D) as catalysts and selecting the types and amounts of the phosphine compound (C) and the acid (D), pot life can be controlled to an arbitrary time in the reaction between a thiol group of the thiol compound (A), an epoxy group of the epoxy compound (B1) and an isocyanate group of the isocyanate compound (E2).

<Curable Composition Kit According to Second Aspect of Present Invention>

Since the thiol compound (A) and the epoxy compound (B1) as well as the thiol compound (A) and the isocyanate compound (E2) react even in the absence of a catalyst, the curable composition according to the second aspect of the present invention is normally used in the form of a two-component curable composition composed of a composition (X), containing the thiol compound (A) but not containing the epoxy compound (B1) and the isocyanate compound (E2), and a composition (Y), containing the epoxy compound (B1) and the isocyanate compound (E2) but not containing the thiol compound (A).

Since the phosphine compound (C) reacts with the epoxy compound (B1), the phosphine compound (C) is contained in the composition (X) that does not contain the epoxy compound (B1).

Since the acid (D) reacts with the epoxy compound (B1) and the isocyanate compound (E2), the acid (D) is contained in the composition (X) that does contain the epoxy compound (B1) or the isocyanate compound (E2).

In addition, as a result of the phosphine compound (C) and the acid (D) being contained in the same composition (X), the phosphine compound (C) and the acid (D) form a complex and an epoxy ring-opening reaction catalyzed by the acid (D) does not proceed.

Thus, the two-component curable composition is preferably composed of the component (X), which contains the thiol compound (A), the phosphine compound (C) and the acid (D), but does not contain the isocyanate compound (B1) and the isocyanate compound (E2), and the composition (Y), which contains the epoxy compound (B1) and the isocyanate compound (E2), but does not contain the thiol compound (A), the phosphine compound (C) and the acid (D).

The two-component curable composition is preferably supplied in the form of a cured composition kit having a first container housing the composition (X) and a second container housing the composition (Y).

According to the curable composition kit according to the second aspect of the present invention, a two-component curable composition can be provided that undergoes little change over time during storage, enables pot life to be controlled to an arbitrary time in a reaction between a thiol group of the thiol compound (A), an epoxy group of the epoxy compound (B1) and an isocyanate group of the isocyanate compound (E2) when mixed, and demonstrates superior handling ease.

<Applications>

(Adhesive)

The curable composition according to the first aspect of the present invention can be used as an adhesive. In the adhesive according to the first aspect of the present invention, superior handling ease is demonstrated when adhering two objects to be adhered and the adhesive can be cured at a low temperature as a result of containing the curable composition according to the first aspect of the present invention that enables pot life to be controlled and allows adhesive to be cured at a low temperature.

The curable composition according to the second aspect of the present invention can also be used as an adhesive. In the adhesive according to the second aspect of the present invention, superior handling ease is demonstrated when adhering two objects to be adhered as a result of containing the curable composition according to the second aspect of the present invention that enables pot life to be controlled.

(Article Having Coating Layer)

The curable composition according to the first aspect of the present invention can be used as a coating agent.

The article according to the first aspect of the present invention has a coating layer that is formed by coating a coating agent containing the curable composition according to the first aspect of the present invention on a substrate followed by curing. In the article according to the first aspect of the present invention, since the coating agent is composed of a cured product of the curable composition according to the first aspect of the present invention, the coating layer demonstrates superior mechanical properties, heat resistance and chemical resistance.

The curable composition according to the second aspect of the present invention can also be used as a coating agent.

The article according to the second aspect of the present invention has a coating layer that is formed by coating a coating agent containing the curable composition according to the second aspect of the present invention on a substrate followed by curing. The coating agent containing the curable composition according to the second aspect of the present invention is able to use a low molecular mass thiol compound, epoxy compound and isocyanate compound to form a coating layer on a substrate by curing, viscosity can be lowered and the use of a solvent can be eliminated. In addition, in the article according to the second aspect of the present invention, since the coating layer is composed of a cured product of the curable composition according to the second aspect of the present invention, the coating layer demonstrates superior mechanical properties (such as toughness, impact resistance and abrasion resistance), heat resistance, chemical resistance and adhesiveness.

(Fiber-Reinforced Composite Material)

The curable composition according to the first aspect of the present invention can be used as a resin for the matrix of a fiber-reinforced composite material.

The fiber-reinforced composite material according to the first aspect of the present invention contains a matrix, composed of a cured product of the curable composition according to the first aspect of the present invention, and reinforcing fibers. The fiber-reinforced composite material according to the first aspect of the present demonstrates superior mechanical properties, heat resistance and chemical resistance since the matrix is composed of a cured product of the curable composition according to the first aspect of the present invention.

The curable composition according to the second aspect of the present invention can be used as a resin for the matrix of a fiber-reinforced composite material.

The fiber-reinforced composite material according to the second aspect of the present invention contains a matrix, composed of a cured product of the curable composition according to the second aspect of the present invention, and reinforcing fibers. The fiber-reinforced composite material according to the second aspect of the present demonstrates superior mechanical properties (such as toughness, impact resistance and abrasion resistance), heat resistance, chemical resistance and adhesiveness since the matrix is composed of a cured product of the curable composition according to the second aspect of the present invention.

(Potting Agent)

The curable composition according to the first aspect of the present invention can be used as a potting agent for immobilizing the ends of hollow fiber membrane bundles in a hollow fiber membrane element.

In the case of the potting agent according to the first aspect of the present invention, as a result of being able to suitably extend pot life, the potting agent prior to curing can be filled between the hollow fiber membrane bundles without forming voids while also being able to secure an adequate amount of time for removing air bubbles.

In the case of the potting agent according to the first aspect of the present invention, as a result of the cured product containing a thiol compound and an epoxy compound, the cured product demonstrates superior solvent resistance. Consequently, the potting agent according to the first aspect of the present invention is preferable for use as a potting agent in a hollow fiber membrane element used to degas a solvent.

The curable composition according to the second aspect of the present invention can be used as a potting agent for immobilizing the ends of hollow fiber membrane bundles in a hollow fiber membrane element.

In the case of the potting agent according to the second aspect of the present invention, as a result of being able to suitably extend pot life, the potting agent prior to curing can be filled between the hollow fiber membrane bundles without forming voids while also being able to secure an adequate amount of time for removing air bubbles.

In the case of the potting agent according to the second aspect of the present invention, as a result of the cured product containing a thiol compound and an epoxy compound, the cured product demonstrates superior solvent resistance. Consequently, the potting agent according to the second aspect of the present invention is preferable for use as a potting agent in a hollow fiber membrane element used to degas a solvent.

Furthermore, since cured products of thiol compounds and epoxy compounds are brittle, potted sections are susceptible to cracking when cutting potted sections of hollow fiber membrane elements composed of these cured products. However, in the case of the potting agent according to the second aspect of the present invention, since the cured product contains a thiol compound and isocyanate compound, the cured product demonstrates superior toughness. Consequently, the potting agent according to the second aspect of the present invention is preferable for use as a potting agent used in a hollow fiber membrane element.

### EXAMPLES

Although the following provides a more detailed explanation of the present invention through examples thereof, the present invention is not limited to these examples.

(Pot Life)

Pot life was measured in the manner indicated below.

### Examples 1 to 18 and Comparative Example 1 to 5

Composition (X) was obtained by adding phosphine compound (C) and acid (D) to thiol compound (A) followed by heating to 100° C. to completely dissolve therein. Epoxy compound (B2) was added to the composition (X) followed by stirring for 30 seconds at room temperature to obtain a homogeneous mixture. The molar ratio of thiol groups to epoxy groups was 70/100.

When the instant at which the epoxy compound (B2) was added to the composition (X) was defined as time 0 and the temperature change of the mixture was recorded with the passage of time using a thermocouple, an exothermic peak was obtained after a prescribed amount of time, and the time from the start of mixing to the appearance of the exothermic peak was defined as pot life.

### Examples 21 to 24 and Comparative Examples 21 to 24

Composition (X) was obtained by adding phosphine compound (C) and acid (D) to thiol compound (A) followed by heating to room temperature or 80° C. to completely dissolve therein. Composition (Y) composed of epoxy compound (B1) and isocyanate compound (E2) was then added to the composition (X) followed by stirring for 30 seconds at room temperature to obtain a homogeneous mixture.

When the instant at which the composition (Y) was added to the composition (X) was defined as time 0 and the temperature change of the mixture was recorded with the passage of time using a thermocouple, an exothermic peak was obtained after a prescribed amount of time, and the time from the start of mixing to the appearance of the exothermic peak was defined as pot life.

(Thiol Compound (A))

PEMP: Pentaerythritol tetrakis(3-mercaptopropionate) (SC Organic Chemical Co., Ltd.)

(Epoxy Compounds (B2) and (B1))

jER828: Bisphenol A glycidyl ether (jER® 828, Mitsubishi Chemical Corp.)

jER630: Triglycidyl aminophenol (jER® 630, Mitsubishi Chemical Corp.)

(Isocyanate Compound (E2))

HMDI: Hexamethylene diisocyanate (Tokyo Chemical Industry Co., Ltd.)

(Phosphine Compound (C))

TMPP: Tris(o-methoxyphenyl)phosphine (Tokyo Chemical Industry Co., Ltd.)

DMOP: Tris(2,6-dimethoxyphenyl)phosphine (Tokyo Chemical Industry Co., Ltd.)

TPP: Triphenylphosphine (Tokyo Chemical Industry Co., Ltd.)

DCPP: Dicyclohexylphenylphosphine (Tokyo Chemical Industry Co., Ltd.)

(Acid (D))

TsOH: p-toluenesulfonic acid (Tokyo Chemical Industry Co., Ltd., pKa: −2.8)

MsOH: Methanesulfonic acid (Tokyo Chemical Industry Co., Ltd., pKa: −1.9)

The pKa value cited in the literature in the case the value was known in the literature, or the calculated value determined using Advanced Chemistry Development (ACD/Labs) software in the case the pKa value was not known, was used for the pKa value of the acid (D) relative to water.

The pKa values cited in Guthrie, et al., Can. J. Chem., 1978, 2342 were used for the pKa values of TsOH and MsOH relative to water.

The melting points contained in the safety data sheet (SDS) of each acid were used for the melting points. Melting point was recorded as 20° C. or higher or under 20° C. after confirming whether the acid was a liquid or solid at 20° C. in the case of acids not having their melting points contained in SDS.

### Examples 1 to 2 and Comparative Example 1

PEMP was used for thiol compound (A), jER828 was used for epoxy compound (B2), TMPP was used for phosphine compound (C) and TsOH was used for acid (D) in Examples 1 and 2. 0.49 parts by mass of TMPP were added based on 100 parts by mass for the total amount of thiol compound (A) and epoxy compound (B2). The incorporated amount of each component, molar ratios and pot lives are shown in Table 1. Acid (D) was not added in Comparative Example 1.

TABLE 1

| TMPP/TsOH, jER828 | | | Comp. Ex. 1 | Ex. 1 | Ex. 2 |
|---|---|---|---|---|---|
| (A) | PEMP | g | 0.86 | 0.86 | 0.86 |
| (B2) | jER828 | g | 1.85 | 1.85 | 1.85 |
| (C) | TMPP | mg | 13.4 | 13.4 | 13.4 |
| | | ppm | 0.49 | 0.49 | 0.49 |
| (D) | TsOH | mg | — | 0.772 | 1.557 |

| | | | | |
|---|---|---|---|---|
| Molar ratios | SH/epoxy | 0.7 | 0.7 | 0.7 |
| | (D)/(C) | — | 0.110 | 0.230 |
| Pot life | min. | 20 | 48 | 99 |

### Examples 3 to 5 and Comparative Example 2

PEMP was used for thiol compound (A), jER828 was used for epoxy compound (B2), TMPP was used for phosphine compound (C) and TsOH was used for acid (D) in Examples 3 to 5. 0.25 parts by mass of TMPP were added based on 100 parts by mass for the total amount of thiol compound (A) and epoxy compound (B2). The incorporated amount of each component, molar ratios and pot lives are shown in Table 2. Acid (D) was not added in Comparative Example 2.

TABLE 2

| TMPP/TsOH, jER828 | | | Comp. Ex. 2 | Ex. 3 | Ex. 4 | Ex. 5 |
|---|---|---|---|---|---|---|
| (A) | PEMP | g | 0.86 | 0.86 | 0.86 | 0.86 |
| (B2) | jER828 | g | 1.85 | 1.85 | 1.85 | 1.85 |
| (C) | TMPP | mg | 6.8 | 6.8 | 6.8 | 6.8 |
| | | ppm | 0.25 | 0.25 | 0.25 | 0.25 |
| (D) | TsOH | mg | — | 0.175 | 0.340 | 0.850 |

| | | | | | |
|---|---|---|---|---|---|
| Molar ratios | SH/epoxy | 0.7 | 0.7 | 0.7 | 0.7 |
| | (D)/(C) | — | 0.053 | 0.102 | 0.256 |
| Pot life | min. | 46 | 56 | 66 | 146 |

### Examples 6 to 8 and Comparative Example 3

PEMP was used for thiol compound (A), jER828 was used for epoxy compound (B2), TMPP was used for phosphine compound (C) and MsOH was used for acid (D) in Examples 6 to 8. 0.49 parts by mass of TMPP were added based on 100 parts by mass for the total amount of thiol compound (A) and epoxy compound (B2). The incorporated amount of each component, molar ratios and pot lives are shown in Table 3. Acid (D) was not added in Comparative Example 3.

TABLE 3

| TMPP/MsOH, jER828 | | | Comp. Ex. 3 | Ex. 6 | Ex. 7 | Ex. 8 |
|---|---|---|---|---|---|---|
| (A) | PEMP | g | 0.86 | 0.86 | 0.86 | 0.86 |
| (B2) | jER828 | g | 1.85 | 1.85 | 1.85 | 1.85 |
| (C) | TMPP | mg | 13.4 | 13.4 | 13.4 | 13.4 |
| | | ppm | 0.49 | 0.49 | 0.49 | 0.49 |
| (D) | MsOH | mg | — | 0.425 | 1.030 | 1.577 |

| | | | | | |
|---|---|---|---|---|---|
| Molar ratios | SH/epoxy | 0.7 | 0.7 | 0.7 | 0.7 |
| | (D)/(C) | — | 0.116 | 0.282 | 0.432 |
| Pot life | min. | 30 | 39 | 63 | 83 |

### Examples 9 to 11 and Comparative Example 4

PEMP was used for thiol compound (A), jER630 was used for epoxy compound (B2), TMPP was used for phosphine compound (C) and TsOH was used for acid (D) in Examples 9 to 11. 0.49 parts by mass to 0.50 parts by mass of TMPP were added based on 100 parts by mass for the total amount of thiol compound (A) and epoxy compound (B2). The incorporated amount of each component, molar ratios and pot lives are shown in Table 4. Acid (D) was not added in Comparative Example 4.

TABLE 4

| TMPP/TsOH, jER630 | | | Comp. Ex. 4 | Ex. 9 | Ex. 10 | Ex. 11 |
|---|---|---|---|---|---|---|
| (A) | PEMP | g | 0.85 | 0.86 | 0.86 | 0.86 |
| (B2) | jER828 | g | 0.96 | 0.98 | 0.98 | 0.99 |
| (C) | TMPP | mg | 9.0 | 9.0 | 9.0 | 9.0 |
| | | ppm | 0.50 | 0.49 | 0.49 | 0.49 |
| (D) | TsOH | mg | — | 0.093 | 0.182 | 0.462 |

| | | | | | |
|---|---|---|---|---|---|
| Molar ratios | SH/epoxy | 0.7 | 0.7 | 0.7 | 0.7 |
| | (D)/(C) | — | 0.021 | 0.041 | 0.105 |
| Pot life | min. | 56 | 72 | 81 | 130 |

### Examples 12 to 18 and Comparative Example 5

PEMP was used for thiol compound (A), jER828 was used for epoxy compound (B2), DMOP was used for phosphine compound (C) and TsOH was used for acid (D) in Examples 12 to 18. 0.25 parts by mass of DMOP were added based on 100 parts by mass for the total amount of thiol compound (A) and epoxy compound (B2). The incorporated amount of each component, molar ratios and pot lives are shown in Table 5. Acid (D) was not added in Comparative Example 5.

TABLE 5

| | | | Comp. | Examples | | | | | | |
|---|---|---|---|---|---|---|---|---|---|---|
| DMOP/TsOH, jER828 | | | Ex. 5 | 12 | 13 | 14 | 15 | 16 | 17 | 18 |
| (A) | PEMP | g | 0.86 | 0.86 | 0.86 | 0.86 | 0.86 | 0.86 | 0.86 | 0.86 |
| (B2) | jER828 | g | 1.85 | 1.85 | 1.85 | 1.85 | 1.85 | 1.85 | 1.85 | 1.85 |
| (C) | DMOP | mg | 6.8 | 6.8 | 6.8 | 6.8 | 6.8 | 6.8 | 6.8 | 6.8 |
| | | ppm | 0.25 | 0.25 | 0.25 | 0.25 | 0.25 | 0.25 | 0.25 | 0.25 |
| (D) | TsOH | mg | — | 0.194 | 0.368 | 0.547 | 0.623 | 0.714 | 0.800 | 0.900 |

| | | | | | | | | | |
|---|---|---|---|---|---|---|---|---|---|
| Molar ratios | SH/epoxy | 0.7 | 0.7 | 0.7 | 0.7 | 0.7 | 0.7 | 0.7 | 0.7 |
| | (D)/(C) | — | 0.073 | 0.139 | 0.207 | 0.235 | 0.270 | 0.302 | 0.340 |
| Pot life | min. | 7 | 8 | 10 | 14 | 19 | 26 | 38 | 47 |

Based on the results for the aforementioned Examples 1 to 18 and Comparative Examples 1 to 5, the addition of acid (D) was determined to enable pot life to be controlled to an arbitrary time without changing the composition of other components.

### Example 21

TsOH (hydrate, pKa: −2.8, melting point: 106° C.) was used in Example 21 and the molar ratio ((D)/(C)) of acid (D) to phosphine compound (C) was 0.0059.

The incorporated amounts of each component are shown in Table 6. TPP and TsOH were added to PEMP followed by heating to 80° C. to completely dissolve. After dissolving, a mixture of jER630 and HMDI was added followed by stirring for 30 seconds at room temperature to obtain a homogeneous mixture. Pot life is shown in Table 6.

### Example 22

The molar ratio of (D)/(C) was 0.0119 in Example 22.

The incorporated amounts of each component are shown in Table 6. The mixture was prepared using the same method as Example 21. Pot life is shown in Table 6.

### Example 23

The molar ratio of (D)/(C) was 0.0178 in Example 23.

The incorporated amounts of each component are shown in Table 6. The mixture was prepared using the same method as Example 21. Pot life is shown in Table 6.

### Example 24

The molar ratio of (D)/(C) was 0.0238 in Example 24.

The incorporated amounts of each component are shown in Table 6. The mixture was prepared using the same method as Example 21. Pot life is shown in Table 6.

### Comparative Example 21

Acid was not added in Comparative Example 21.

The incorporated amounts of each component are shown in Table 6. The mixture was prepared using the same method as Example 21. Pot life is shown in Table 6.

### Comparative Example 22

Acid was not added in Comparative Example 22.

The incorporated amounts of each component are shown in Table 6. TPP was added to PEMP followed by heating to 80° C. to completely dissolve. After dissolving, a mixture of jER828 and HMDI was added followed by stirring for 30 seconds at room temperature to obtain a homogeneous mixture. Pot life is shown in Table 6.

### Comparative Example 23

Acid was not added in Comparative Example 23.

The incorporated amounts of each component are shown in Table 6. The mixture was prepared using the same method as Comparative Example 22. Pot life is shown in Table 6.

### Comparative Example 24

Acid was not added in Comparative Example 24.

The incorporated amounts of each component are shown in Table 6. DCPP was added to PEMP followed by heating to 80° C. to completely dissolve. After dissolving, a mixture of jER828 and HMDI was added followed by stirring for 30 seconds at room temperature to obtain a homogeneous mixture. Pot life is shown in Table 6.

TABLE 6

| | | Examples | | | | Comparative Examples | | | |
|---|---|---|---|---|---|---|---|---|---|
| | | 21 | 22 | 23 | 24 | 21 | 22 | 23 | 24 |
| (A) | PEMP(g) | 1.04 | 1.04 | 1.04 | 1.04 | 1.04 | 0.61 | 0.61 | 0.61 |
| (B1) | jER630(g) | 0.49 | 0.49 | 0.49 | 0.49 | 0.49 | — | — | — |
| (B1) | jER828(g) | — | — | — | — | — | 0.47 | 0.47 | 0.47 |
| (E2) | HMDI(g) | 0.42 | 0.42 | 0.42 | 0.42 | 0.42 | 0.21 | 0.21 | 0.21 |
| (C) | TPP(mg) | 10 | 10 | 10 | 10 | 10 | 13 | 6 | — |
| (C) | DCPP(mg) | — | — | — | — | — | — | — | 6 |
| (D) | TsOH(mg) | 0.039 | 0.078 | 0.117 | 0.156 | — | — | — | — |

| | | | | | | | | |
|---|---|---|---|---|---|---|---|---|
| Molar ratio | 0.0059 | 0.0119 | 0.0178 | 0.0238 | — | — | — | — |
| ((D)/(C)) | | | | | | | | |
| Pot life (min) | 10 | 24 | 42 | 64 | 6 | 9 | 10 | 3 |

Based on the results for Examples 21 to 24 and Comparative Example 21, the addition of acid (D) was determined to enable pot life to be controlled to an arbitrary time without changing the composition of other components.

Based on the results for Comparative Examples 22 and 23, in the case of not adding acid (D), there was no significant change in pot life and pot life was determined to be unable to be controlled to an arbitrary time even if considerable changes were made in the added amount of phosphine compound (C).

Based on the results of Comparative Examples 23 and 24, pot life exhibited extreme fluctuations and was determined to be difficult to control to an arbitrary time if the type of phosphine compound (C) was changed without adding acid (D).

### INDUSTRIAL APPLICABILITY

The curable composition according to the first aspect of the present invention and the curable composition according to the second aspect of the present invention are extremely useful as an adhesive, coating agent, resin for the matrix of a fiber-reinforced composite material, and potting agent for immobilizing the ends of hollow fiber membrane bundles in a hollow fiber membrane element.

1. A curable composition, containing:
a thiol compound (A) having at least two thiol groups in a molecule thereof,
an epoxy compound (B2) having at least two epoxy groups in a molecule thereof,
a phosphine compound (C), and
an acid (D).

2. The curable composition according to claim 1, further containing an isocyanate compound (E1) having one isocyanate group in a molecule thereof.

3. The curable composition according to claim 1, wherein the amount of the phosphine compound (C) is 0.1 parts by mass to 5 parts by mass based on the total amount (100 parts by mass) of the thiol compound (A), the epoxy compound (B2) and an isocyanate compound (E1) having one isocyanate group in a molecule thereof.

4. A curable composition, containing:
a thiol compound (A) having at least two thiol groups in a molecule thereof,
an epoxy compound (B1) having at least one epoxy group in a molecule thereof,
an isocyanate compound (E2) having at least two isocyanate groups in a molecule thereof,
a phosphine compound (C), and
an acid (D).

5. The curable composition according to claim 4, wherein the amount of the phosphine compound (C) is 0.1 parts by mass to 5 parts by mass based on the total amount (100 parts by mass) of the thiol compound (A), the epoxy compound (B1) and the isocyanate compound (E2).

6. The curable composition according to claim 1 or 4, wherein the acid dissociation constant (pKa) of the acid (D) relative to water is 3 or less.

7. The curable composition according to claim 1 or 4, wherein the phosphine compound (C) is a compound represented by the following formula (I): 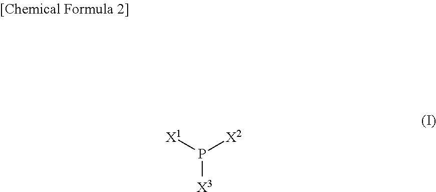
wherein, X¹, X² and X³ respectively represent an alkyl group having 1 to 8 carbon atoms, alkoxy group having 1 to 8 carbon atoms, alkenyl group having 1 to 8 carbon atoms, alkynyl group having 1 to 8 carbon atoms, cycloalkyl group having 3 to 6 carbon atoms, phenyl group, biphenyl group, naphthyl group, phenoxy group or heterocyclic group, X¹, X² and X³ may have a substituent, and the substituent is at least one group selected from the group consisting of a halogen atom, alkyl group having 1 to 8 carbon atoms, alkoxy group having 1 to 8 carbon atoms, alkenyl group having 1 to 8 carbon atoms, alkynyl group having 1 to 8 carbon atoms, cycloalkyl group having 3 to 6 carbon atoms, amino group, alkylamino group having 1 to 8 carbon atoms, nitro group, phenyl group, biphenyl group, naphthyl group, phenoxy group and heterocyclic group.

8. The curable composition according to claim 1 or 4, wherein the molar ratio ((D)/(C)) of the acid (D) to the phosphine compound (C) is 0.001 to 1.

9. An adhesive containing the curable composition according to claim 1 or 4.

10. An article having a coating layer composed of the curable composition according to claim 1 or 4.

11. A fiber-reinforced composite material containing a matrix, composed of a cured product of the curable composition according to claim 1 or 4, and reinforcing fibers.

12. A potting agent for immobilizing the ends of hollow fiber membrane bundles in a hollow fiber membrane element, containing the curable composition according to claim 1 or 4.

13. A curable composition kit, having:
a first container housing a composition (X) containing a thiol compound (A) having at least two thiol groups in a molecule thereof, a phosphine compound (C) and an acid (D), but not containing the following epoxy compound (B2); and,
a second container housing a composition (Y) housing only the epoxy compound (B2) having at least two epoxy groups in a molecule thereof, or containing the epoxy compound (B2), but not containing the thiol compound (A), the phosphine compound (C) or the acid (D).

14. The curable composition kit according to claim 13, wherein the composition (X) also does not contain the following isocyanate compound (E1), and
the composition (Y) contains the epoxy compound (B2) and the isocyanate compound (E1) having one isocyanate group in a molecule thereof.

15. A curable composition kit, having:
a first container housing a composition (X) containing a thiol compound (A) having at least two thiol groups in a molecular thereof, a phosphine compound (C) and an acid (D), but not containing the following epoxy compound (B1) or the following isocyanate compound (E2); and,
a second container housing a composition (Y) containing the epoxy compound (B1) having at least one epoxy group in a molecular thereof and the isocyanate compound (E2) having at least two isocyanate groups in a molecule thereof, but not containing the thiol compound (A), the phosphine compound (C) or the acid (D).
